(19) United States
(12) Patent Application Publication
(10) Pub. No.: US 2004/0012629 A1
(43) Pub. Date: Jan. 22, 2004

(54) Apparatus and method for generating an interface overlay

(76) Inventor: Reid L. Walters, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/196,969

(22) Filed: Jul. 17, 2002

(51) Int. Cl. G09G 5/00

(52) U.S. Cl. 345/747; 345/762

(57) ABSTRACT

An interface overlay is generated for a device. A language for the interface overlay is identified. The identified language is matched to one of the templates for the interface overlay. The matched template is reproduced on overlay media.

### FIELD OF THE INVENTION

This invention relates in general to interface overlay technology and, more particularly, to generating an interface overlay in a selected language.

### BACKGROUND OF THE INVENTION

Interface overlays are used with a wide variety of devices to provide information to users of the devices. For example, an interface overlay may be used on a user interface of a device to label the buttons and displays of the user interface.

Often, interface overlays are language specific. To provide the user of the device with meaningful information, the interface overlay is in a language known to the user.

It is not unusual for devices to be manufactured in one location and used worldwide. At the time the device is manufactured, the user's language may not be known. Often interface overlays are manufactured in a variety of languages and only affixed to the device once the destination of the device is known.

Conventionally, interface overlays are made of molded plastic and interface graphics are silk screened onto the molded plastic. The conventional process for manufacturing these interface overlays requires more than an insignificant amount of time.

In order to timely meet customer demand for a device, interface overlays are usually manufactured in a variety of languages before the destinations of the devices are known. That ensures there will be no delay in shipping the device while waiting for the interface overlays to be manufactured.

Since the destinations of the devices are not usually known prior to the manufacture of the interface overlays, the number of overlays required is estimated. Since the number of overlays required is only an estimation, often the number of available overlays is either too high or too low. When the number of available interface overlays is too high, the cost of their manufacture is a wasted expense. When the number of available interface overlays is too low, delays in shipping the devices may result, while additional interface overlays are manufactured.

### SUMMARY OF THE INVENTION

According to principles of the present invention, in one embodiment, an interface overlay is generated for a device. A language for the interface overlay is identified. The identified language is matched to one of the templates for the interface overlay. The matched template is reproduced on overlay media.

### DESCRIPTION OF THE DRAWINGS

FIG. 1 is a block diagram of one embodiment of the present invention system for generating an interface overlay for a device.

FIG. 2 illustrates an example interface overlay generated by one embodiment of the system and method of the present invention.

FIG. 3 is a flow chart illustrating one embodiment of the present invention method for generating an interface overlay for a device.

### DETAILED DESCRIPTION OF THE INVENTION

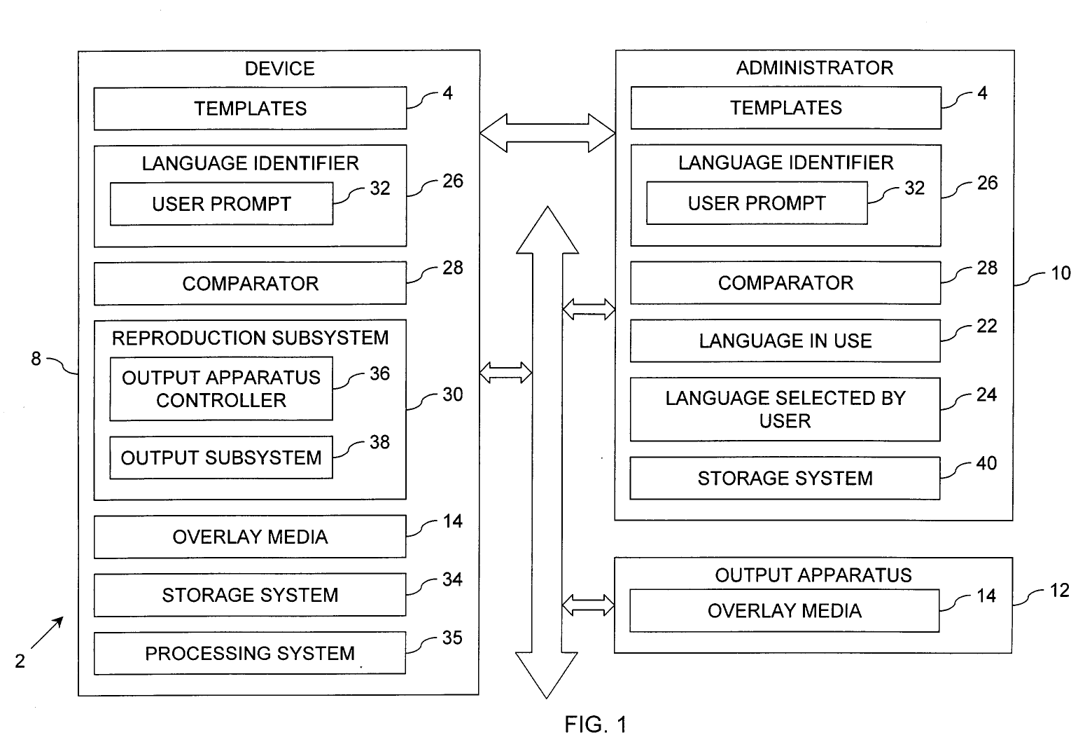

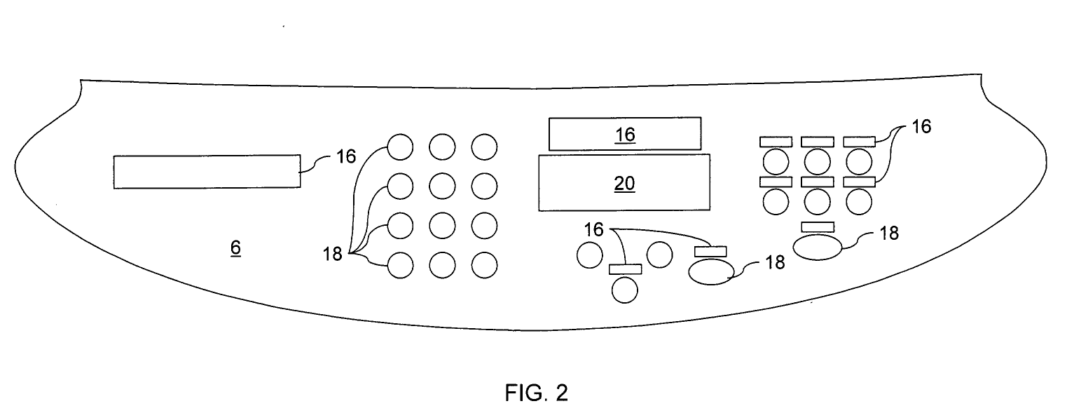

Illustrated in FIG. 1 is one embodiment of an interface overlay generating system 2 of the present invention. In one embodiment, interface overlay generating system 2 includes at least one template 4 for an interface overlay 6 (FIG. 2), a device 8, and optionally an administrator 10 and an output apparatus 12.

Each template 4 is an image representing an interface overlay 6. FIG. 1 alternatively shows templates 4 within both device 8 and administrator 10. Templates 4 are shown in both device 8 and administrator 10 to illustrate that templates 4 could be within either device 8 or administrator 10. Alternatively templates 4 reside outside of both device 8 and administrator 10, but accessible either by device 8 or output apparatus 12.

FIG. 2 illustrates one example of interface overlay 6. Interface overlay 6 includes overlay media 14 upon which one of the templates 4 is reproduced. Templates 4 include at least one text or graphic area 16 for providing information to users of device 8.

Overlay media 14 is any media suitable for use as an interface overlay 6. Examples of overlay media 14 include paper and plastic media. In one embodiment, overlay media 14 includes an adhesive backing. In an alternative embodiment, overlay media 14 does not include an adhesive backing. In one embodiment, template 4 is reproduced on the front of overlay media 14. In an alternative embodiment, template 4 is reproduced on the back of overlay media 14. In one embodiment, overlay media 14 includes openings, knockouts, or cutouts to allow user inputs 18 to be accessed through overlay media 14. For clarity of illustration, not all text or graphic areas 16 and user inputs 18 are labeled. In an alternative embodiment, user inputs 18 are accessed through overlay media 14 without openings, knockouts, or cutouts. Similarly, in one embodiment, overlay media 14 includes openings, knockouts, or cutouts to allow user displays 20 to be accessed through overlay media 14. In an alternative embodiment, user displays 20 are accessed through overlay media 14 without openings, knockouts, or cutouts.

Referring again to FIG. 1, in one embodiment, device 8 is any device configured to identify a language for interface overlay 6, match the identified language to one of the templates 4 for interface overlay 6, and reproduce the matched template 4 on overlay media 14. Examples of device 8 include a printer, a plotter, facsimile machine, a copier, a multifunction device, and a scanner.

In one embodiment, administrator 10 is any device or system configured to administrate device 8. Administrator 10 includes a language 22 in use and optionally, a language 24 selected by a user of administrator 10. The language 22 in use is the language used by administrator 10 when presenting information to a user of administrator 10. The language 24 selected by a user is a language selected by the user for producing interface overlay 6. Administrator 10 communicates with device 8 in any manner. Examples of manners in which administrator 10 communicates with device 8 include over a network and locally.

Output apparatus 12 is any device or system configured to generate template 4 onto overlay media 14. Examples of output apparatus 12 include a printer, a plotter, facsimile machine, a copier, and a multifunction device. Output apparatus 12 communicates with device 8 in any manner. Examples of manners in which output apparatus 12 communicates with device 8 include over a network and locally.

In an alternative embodiment, overlay generating system 2 includes at least one template 4 for the interface overlay 6, language identifier 26, comparator 28, device 8, and optionally, administrator 10 and output device 12.

Device 8 is any device having a user interface. Device 8 includes reproduction subsystem 30 and optionally, templates 4, language identifier 26, comparator 28, storage system 34, and processing system 35. Processing system 35 is any device or system configured to process or execute executable code. Examples of device 8 include a printer, a plotter, facsimile machine, a copier, a multifunction device, and a scanner.

Language identifier 26 is any means for identifying a language for interface overlay 6. In one example, language identifier 26 is any combination of executable code and hardware configured to identify a language for interface overlay 6. Executable code is any code capable of being executed by processing system 35. Examples of executable code include firmware and software code

In one embodiment, language identifier 26 resides on device 8. In an alternate embodiment, language identifier 26 resides on administrator 10. Alternatively, language identifier 26 does not reside on either device 8 or administrator 10, but is able to access device 8.

In one embodiment, language identifier 26 includes a user prompt 32. User prompt 32 is any means for prompting a user for a language selection. In one example, user prompt 32 is any combination of executable code and hardware configured to prompt a user for a language selection. User prompt 32 is configured to prompt alternatively a user of device 8 or a user of administrator 10.

Comparator 28 is any means for matching an identified language to one of the templates 4 for interface overlay 6. In one example, comparator 28 is any combination of executable code and hardware configured to match an identified language to one of the templates 4. In one embodiment, comparator 28 resides on device 8. In an alternate embodiment, comparator 28 resides on administrator 10. Alternatively, comparator 28 does not reside on either device 8 or administrator 10.

Reproduction subsystem 30 is any means for reproducing the matched template 4 on overlay media 14. In one example, reproduction subsystem 30 is any combination of executable code and hardware configured to reproduce a template 4 on overlay media 14. In one embodiment, reproduction subsystem 30 includes output apparatus controller 36. Output apparatus controller 36 is any means for directing output apparatus 12 to generate template 4 on overlay media 14. In an alternate embodiment, reproduction subsystem 30 includes output subsystem 38. Output subsystem 38 is any hardware means for generating template 4 on overlay media 14.

Storage system 34 is any device or system configured to store data or executable code. Storage system 34 may also be a program storage system tangibly embodying a program, applet, or instructions executable by processing system 35 for performing the method steps of the present invention executable by processing system 35. Storage system 34 may be any type of storage media such as magnetic, optical, or electronic storage media. Storage system 34 is illustrated in FIG. 1 as a single device. Alternatively, storage system 34 may include more than one device. Furthermore, each device of storage system 34 may be embodied in a different media type. For example, one device of storage system 34 may be a magnetic storage media while another device of storage system 34 is an electronic storage media.

In one embodiment, administrator 10 is any device or system configured to administrate device 8. Optionally, administrator 10 includes templates 4, language 22 in use, language 24 selected by a user, language identifier 26, comparator 28, and storage system 40.

Storage system 40 is any device or system configured to store data or executable code. Storage system 40 may also be a program storage system tangibly embodying a program, applet, or instructions executable by processing system 35 for performing the method steps of the present invention executable by processing system 35. Storage system 40 may be any type of storage media such as magnetic, optical, or electronic storage media. Storage system 40 is illustrated in FIG. 1 as a single device. Alternatively, storage system 40 may include more than one device. Furthermore, each device of storage system 40 may be embodied in a different media type. For example, one device of storage system 40 may be a magnetic storage media while another device of storage system 40 is an electronic storage media.

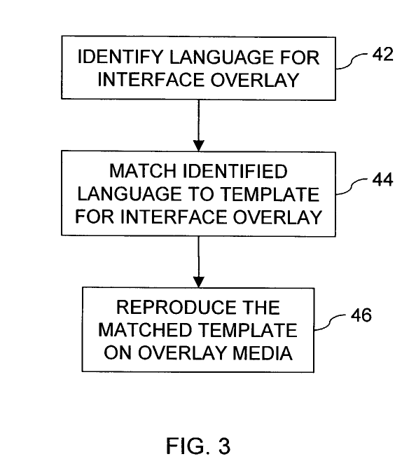

FIG. 3 is a flow chart representing steps of one embodiment of the present invention. Although the steps represented in FIG. 3 are presented in a specific order, the present invention encompasses variations in the order of steps. Furthermore, additional steps may be executed between the steps illustrated in FIG. 3 without departing from the scope of the present invention.

A language for the interface overlay is identified by block 42. In one embodiment, the language is identified at block 42 by device 8 prompting a user of device 8 for a language selection. The language selection is the identified language. In an alternative embodiment, the language is identified at block 42 by recognizing a language of administrator 10. The recognized language is the identified language. In another alternative embodiment, the language is identified at block 42 by prompting a user of administrator 10 for a language selection. The language selection is the identified language.

The identified language is matched by block 44 to one of the templates 4 for the interface overlay 6.

Matched template 4 is reproduced by block 46 on overlay media 14. In one embodiment, matched template 4 is reproduced at block 46 by device 8 directing output apparatus 12 to generate matched template 4 on overlay media 14. In another embodiment, matched template 4 is reproduced at block 46 by device 8 generating matched template 4 on overlay media 14.

In one embodiment, matched template 4 is reproduced at block 46 on adhesive backed overlay media 14. In one embodiment, matched template 4 is reproduced at block 46 on the front of overlay media 14. In an alternative embodiment, matched template 4 is reproduced at block 46 on the back of overlay media 14.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for generating an interface overlay for a device, the method comprising:
(a) identifying a language for the interface overlay;
(b) matching the identified language to one of the templates for the interface overlay; and,
(c) the device reproducing the matched template on overlay media.

2. The method of claim 1 wherein identifying the language for the interface overlay includes the device prompting a user of the device for a language selection.

3. The method of claim 1 wherein identifying the language for the interface overlay includes recognizing a language of an administrator.

4. The method of claim 1 wherein identifying the language for the interface overlay includes prompting a user of an administrator for a language selection.

5. The method of claim 1 wherein the device reproducing the matched template on overlay media includes the device directing an output apparatus to generate the matched template on overlay media.

6. The method of claim 1 wherein the device reproducing the matched template on overlay media includes the device generating the matched template on overlay media.

7. A system for generating an interface overlay for a device, the system comprising:
(a) at least one template for the interface overlay; and,
(b) a device configured to identify a language for the interface overlay, to match the identified language to one of the templates for the interface overlay, and to reproduce the matched template on overlay media.

8. The system of claim 7 further including an output apparatus and wherein the device configured to reproduce the matched template includes the device configured to direct the output apparatus to generate the matched template on overlay media.

9. The system of claim 7 wherein the device configured to reproduce the matched template includes the device configured to generate the matched template on overlay media.

10. The system of claim 7 further including an administrator and wherein the identified language includes a language in use by the administrator.

11. The system of claim 7 further including an administrator and wherein the identified language includes a language selected by a user of the administrator.

12. A system for generating an interface overlay for a device, the system comprising:
(a) at least one template for the interface overlay;
(b) means for identifying a language for the interface overlay;
(c) means for matching the identified language to one of the templates for the interface overlay; and
(d) a device having means for reproducing the matched template on overlay media.

13. The system of claim 12 wherein the means for identifying a language for the interface overlay includes means of the device for prompting a user of the device for a language selection.

14. The system of claim 12 further including an administrator and wherein the identified language includes a language in use by the administrator.

15. The system of claim 12 further including an administrator and wherein the identified language includes a language selected by a user of the administrator.

16. The system of claim 12 further including an output apparatus and wherein the means of the device for reproducing includes means of the device for directing the output apparatus to generate the matched template on overlay media.

17. The system of claim 12 wherein the means of the device for reproducing includes means of the device for generating the matched template on overlay media.

18. A program storage system readable by a computer, tangibly embodying a program, applet, or instructions executable by the computer to perform method steps for generating an interface overlay for a device, the method steps comprising:
(a) identifying a language for the interface overlay;
(b) matching the identified language to one of the templates for the interface overlay; and,
(c) the device reproducing the matched template on overlay media.

19. The program storage system of claim 18 wherein the method step of identifying the language for the interface overlay includes the device prompting a user of the device for a language selection.

20. The program storage system of claim 18 wherein the method step of identifying the language for the interface overlay includes recognizing a language of an administrator.

21. The program storage system of claim 18 wherein the method step of identifying the language for the interface overlay includes prompting a user of an administrator for a language selection.

22. The program storage system of claim 18 wherein the method step of the device reproducing the matched template on overlay media includes directing the device to generate the matched template on overlay media.

23. The program storage system of claim 18 wherein the method step of the device reproducing the matched template on overlay media includes the device generating the matched template on overlay media.
